(19) United States
(12) Patent Application Publication
(10) Pub. No.: US 2018/0270100 A1
(43) Pub. Date: Sep. 20, 2018

(54) METHOD AND APPARATUS FOR DATA TRANSFER BETWEEN NETWORK DEVICES

(71) Applicant: THOMSON LICENSING, Issy les Moulineaux (FR)

(72) Inventors: Tao ZHOU, Hangzhou (CN); Ming Pan, Hangzhou (CN); Zhenzhong Lu, Hangzhou (CN); Ye Bao, Hangzhou (CN)

(21) Appl. No.: 15/537,570

(22) PCT Filed: Dec. 19, 2014
(86) PCT No.: PCT/CN2014/094414

§ 371 Date: Jun. 19, 2017

(51) Int. Cl. H04L 12/24; H04L 29/08; G06F 17/30

(52) U.S. Cl. CPC H04L 41/0213; H04L 67/06; G06F 17/30153; G06F 17/30203; G06F 17/30115

(57) ABSTRACT

A method and an apparatus for data transfer between network devices are suggested. It is proposed to introduce a network file transfer protocol into the data transfer between a NMS and a NE in order to improve the communication efficiency there between. Generally, when a NMS is to retrieve data from a NE, it will send a message to the NE to prepare a data file which can support a network file transfer protocol. Then the data file will be transmitted from the NE to the NMS by the network file transfer protocol.

### TECHNICAL FIELD

The present disclosure generally relates to data management technologies. In particular, the present disclosure relates to a method for data transfer between network devices and corresponding network devices.

### BACKGROUND

Simple Network Management Protocol (SNMP) is an Internet-standard protocol for managing devices on IP networks, which is a component of the Internet Protocol Suite as defined by the IETF (Internet Engineering Task Force). SNMP has been widely used in network management systems (NMSs).

The US patent publication US20080104221A1, filed on Jan. 4, 2008, titled “method and system for Simple Network Management Protocol based data management”, proposes to add a data management node for managing data into the SNMP MIB (Management Information Base) shared by the network manager and a network element (NE). According to the proposal of US20080104221A1, the network manager can manage the data on the NE remotely and save the time and fund cost in the data management and maintenance operation.

Though SNMP protocol is simple to use, it is not efficient in data transfer. For example, it may need hundreds of packets for transferring data of a single SNMP MIB table from NE to NMS. Some SNMP MIB tables contain huge rows of data for network device, and the number of rows may exceed 1,000. In such case, when querying table data from a NMS to a NE, the network communication between NMS and NE will be slow and requires hundreds even thousands of network packets to finish. There are some extension protocols to address this issue, which however are complicated in use.

Therefore, there is a need to make further improvement of the SNMP-based network management in term of the efficiency.

### SUMMARY

According to a first aspect of the disclosure, a method for data transfer between a first network device and a second network device is provided. The method comprises, at the level of the first network device: receiving, from the second network device, a request for retrieving data from a SNMP table; and creating a file which includes data of the SNMP table and supports a network file transfer protocol.

In an embodiment, the first network device is a network element and the second network device is a server.

In an embodiment, the method further comprises creating a new row in the SNMP table for indicating whether the process of the file creation is completed.

In an embodiment, the method further comprises transmitting a message to the second network device to notify the second network device that the process of the file creation is completed.

In an embodiment, the method further comprises compressing the created file.

In an embodiment, the network file transfer protocol is TFTP (Trivial File Transfer Protocol).

In an embodiment, the network file transfer protocol is FTP (File Transfer Protocol).

According to a second aspect of the disclosure, a method for data transfer between a first network device and a second network device is provided. The method comprises, at the level of the second network device: transmitting, to the first network device, a request for retrieving data from a SNMP table; and receiving a file from the first network device by a network file transfer protocol.

In an embodiment, the first network device is a network element and the second network device is a server.

In an embodiment, the method further comprises checking the availability of the file transfer before receiving the file.

In an embodiment, the method further comprises retrieving the SNMP table of the first network device to get a transaction ID of the request and a status indicating whether a creation a file indicated by the transaction ID is completed.

In an embodiment, the method further comprises receiving a message from the first network device notifying that the process of the file creation is completed.

In an embodiment, the request is in the form of a SNMP Set command.

In an embodiment, the network file transfer protocol is TFTP (Trivial File Transfer Protocol).

In an embodiment, the network file transfer protocol is FTP (File Transfer Protocol).

According to a third aspect of the disclosure, an apparatus is provided. The apparatus comprises: an interface configured to exchange packets with an external device; a memory configured to store data required for operation of the apparatus; and a processor configured to: receive, from the external device, a request for retrieving data from a SNMP table; and create a file which includes data of the SNMP table and supports a network file transfer protocol.

In an embodiment, the apparatus functions as a network element.

According to a fourth aspect of the disclosure, an apparatus is provided. The apparatus comprises: an interface configured to exchange packets with an external device; a memory configured to store data required for operation of the apparatus; and a processor configured to: transmit, to the external device, a request for retrieving data from a SNMP table; and receive a file from the external device by a network file transfer protocol.

In an embodiment, the apparatus functions as a network management server.

According to a fifth aspect of the disclosure, there is provided a computer program product downloadable from a communication network and/or recorded on a medium readable by computer and/or executable by a processor, comprising program code instructions for implementing the steps of a method according to the first and second aspects of the disclosure.

According to a sixth aspect of the present disclosure, there is provided Non-transitory computer-readable medium comprising a computer program product recorded thereon and capable of being run by a processor, including program code instructions for implementing the steps of a method according to the first and second aspects of the disclosure.

It is to be understood that more aspects and advantages of the disclosure will be found in the following detailed description of the present disclosure.

### BRIEF DESCRIPTION OF THE DRAWINGS

The accompanying drawings are included to provide further understanding of the embodiments of the disclosure together with the description which serves to explain the principle of the embodiments. The disclosure is not limited to the embodiments.

In the drawings:

FIG. 1 is an exemplary flowchart showing the data transfer between a NMS and a NE according to an embodiment of the disclosure;

FIG. 2 is an exemplary diagram showing an example of the SNMP table according to an embodiment of the disclosure;

FIG. 3 is an exemplary diagram showing an example of the file header of the created file according to an embodiment of the disclosure;

FIG. 4 is a block diagram schematically showing a NE according to an embodiment of the present disclosure; and

FIG. 5 is a block diagram schematically showing a NMS according to an embodiment of the present disclosure.

### DETAILED DESCRIPTION

An embodiment of the present disclosure will now be described in detail in conjunction with the drawings. In the following description, some detailed descriptions of known functions and configurations may be omitted for conciseness.

A telecommunications network generally comprises one or more network devices (NEs) and management software which may be operating on a NMS. The NEs and NMS can communicate with the SNMP protocol. For example, in some context, the NE can be a mini-CMTS (mini cable modem terminal system) or an OLT (Optical Line Terminal) device. In this case, the NMS contains the software, on a server, for managing all these mini-CMTS or OLT devices remotely using the SNMP protocol.

The SNMP protocol supports two basic data structures which are table and scalar, and four basic operations which are Get, GetNext, Getbulk and Set. The SNMP table is like a database table, which can hold many rows of data therein. SNMP Get operation can retrieve one row of data once a time. Suppose there is one table containing hundreds or thousands rows of data, such as table for cable modem information, it will require hundreds times of communication between the NMS and the NE to get all these data. This process may take a time from tens of seconds to several minutes, which is quite slow and inefficient in most cases. There is a need for a solution of data transfer between a NMS and a NE which can reduce the process time and improve the transfer efficiency.

TFTP (Trivial File Transfer Protocol)/FTP(File Transfer Protocol) are network file transfer protocols which allow a client device to get or put a file onto a remote host. TFTP and FTP have been used for the application of file transfer because they are efficient for file transfer over network and at the same time simple to implement.

Embodiments of the disclosure propose to introduce a network file transfer protocol into the data transfer between a NMS and a NE in order to improve the communication efficiency therebetween. Generally, when a NMS is to retrieve data from a NE with SNMP table, it will send a message to the NE to prepare a data file which can support a network file transfer protocol. Then the data file will be transmitted from the NE to the NMS according to the network file transfer protocol.

An embodiment of the present disclosure provides a method for data transfer between a NMS and a NE.

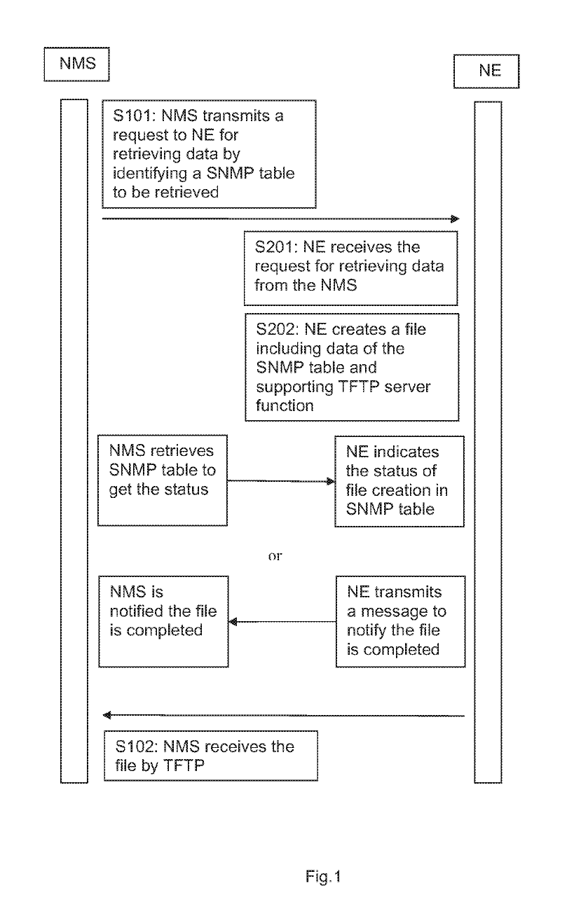

FIG. 1 is an exemplary flowchart showing the data transfer between a NMS and a NE according to an embodiment of the disclosure.

For purpose of the data transfer between NMS and NE, a SNMP table is defined.

The SNMP table can be created and maintained by the NE. But it can be appreciated that the definition and format of the table will be known by both the NE and the NMS for purpose of the communication therebetween.

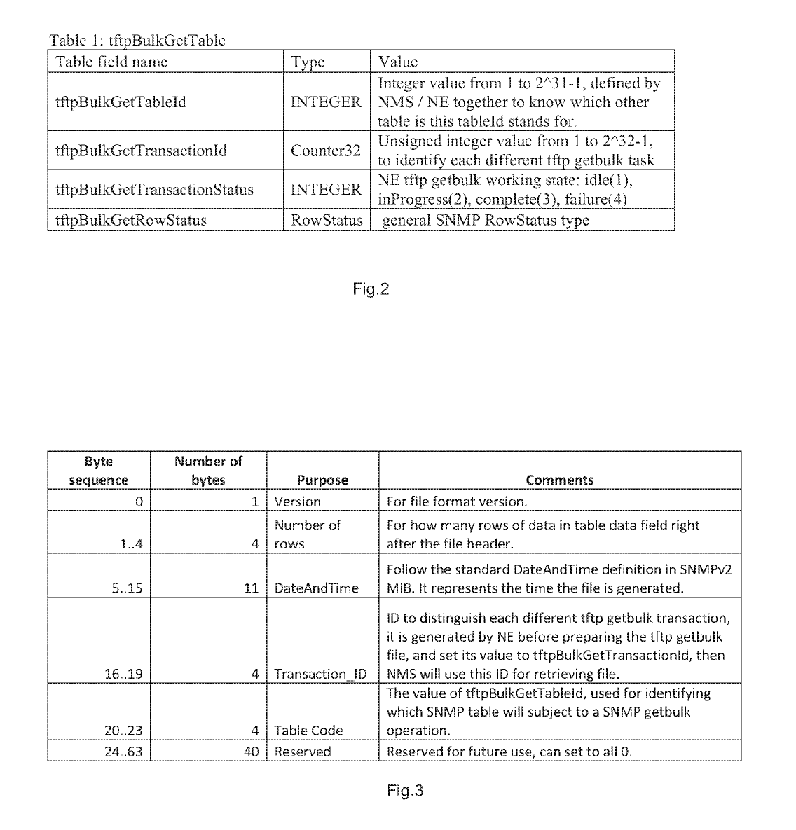

FIG. 2 is an exemplary diagram showing an example of the SNMP table according to an embodiment of the disclosure. As shown in FIG. 2, a standard

SNMP table 1 is in the name of “tftpBulkGetTable” and has four items.

In the table “tftpBulkGetTable”, “tftpBulkGetTableId” is in INTEGER type and act as the identifier of all the tables pre-defined by NMS and NE in both sides to share the same definition. “tftpBulkGetTableId” can be integers. For example, 1 stands for SNMP table “cmInfoTable” for all Cable Modem information, 2 stands for table “cpeInfoTable” for all CPE(Customer Premise Equipment) information, and so on. So when specifying “tftpBulkGetTableId” to value 1, NMS and NE will both know it is for requesting table data for “cmInfoTable”.

“tftpBulkGetTransactionId” is used to distinguish which NMS server is communicating with NE in type Counter32, which is a standard SNMP type representing a non-negative integer in range from 1 to 2̂32-1 (4294967295 decimal). This value is different for every tftp getbulk transaction.

“tftpBulkGetTransactionStatus” is used to indicate the transfer status. “tftpBulkGetTableId” can be integers. For example, “1” represents the status of idle, which means there is no tftp getbulk processing in NE; “2” represents the status of in progress, which means NE is processing and preparing the file containing all the data for the table defined by “tftpBulkGetTableId”; “3” represents the status of complete, which means that NE has generated the data for table defined by “tftpBulkGetTableId”; “4” represents the status of failure, which indicates some error occurs during the process. The NMS can query this value periodically to know whether the file is ready in NE, and then start TFTP bulk get process if the status is complete(3).

“tftpBulkGetRowStatus” is the typical RowStatus in SNMP protocol, which is an integer defined in RFC 1903 (https://www.ietf.org/rfc/rfc1903.txt). In SMIv2 tables, the RowStatus column is used to manage the creation and deletion of conceptual rows. The value range is: active(1), notInService(2), notReady(3), createAndGo(4), createAndWait(5), destroy(6). For creating a new record, NMS will set tftpBulkGetRowStatus value to be createAndGo(4).

As shown in FIG. 1, at step S101, the NMS transmits a request for retrieving data from the NE by identifying which SNMP table to be retrieved using tftpBulkGetTableId as details described below. The request can be implemented by transmitting a SNMP Set command from NMS to the NE. In this embodiment, the target NE can support the above-described SNMP MIB table named tftpBulkGetTable. The SNMP Set request can be set as TFTP bulkget request by creating a new row in the tftpBulkGetTable table of the NE. The SNMP Set request from NMS will specify table tftpBulkGetTableId and set tftpBulkGetRowStatus to be createAndGo(4). At step S201, the NE receives the request for retrieving data from the NMS.

At step S202, upon receipt of the request, the NE creates a file which includes data of the requested SNMP table and supports TFTP server function. The TFTP server function allows a TFTP client (in most cases, the NMS) to get the file from a NE according to TFTP protocol.

Generally, this step can comprise the following steps of:

collecting all the rows in the requested SNMB MIB table into a file;

maintaining a file collection status and update the status; and

setting a transaction ID for the file.

Next, this process will be described in details based on the structure of the above-described SNMP MIB table “tftpBulkGetTable”.

The NE can create a row in tftpBulkGetTable table and a tftpBulkGetTransactionId for this TFTP getbulk request, and change corresponding tftpBulkGetTransactionStatus to be inProgress(2). As described above, possible values of tftpBulkGetTransactionStatus include: idle(1), inProgress(2), complete(3), and failed(4). The NE can collect all data in the table requested by tftpBulkGetTableId, then encapsulates the data into a file with binary format. The file can be named table_bulkget_file.

As described above, the created file can support TFTP server function which allows the NMS to get the file from the NE according to TFTP protocol. It can be appreciated that TFTP is a protocol for transferring files, implemented on top of the UDP/IP protocols using IANA (International Assigned Numbers Authority) registered port number 69. Generally an initiating host (the NMS in this example) sends an RRQ (read request) or WRQ (write request) packet to source host (the NE in this example) at port number 69, containing the filename, transfer mode, and optionally any negotiated option under the terms of RFC 2347. Then the source host sends requested DATA packets or files to the initiating host. No further details about TFTP protocol will be provided.

Specifically, for purpose of the file transfer, the TFTP protocol port is set as 69. The NE can close the transaction after a predetermined period once the file collection is failed. For example, the predetermined period can be ten seconds. The NE can also be set to support a maximum number of table bulkget transactions simultaneously. For example, the NE can be set to support at most 5 table bulkget transactions simultaneously.

In addition, the NE can be set to support an aging time for a transaction. For example, the following policies can be set in this respect:

1) The aging time is fixed to 5 minutes.

2) It is started after the table_bulkget_file is ready for get the file according to TFTP protocol.

3) When the aging timer expires, the table_bulkget_file shall be deleted and the transaction shall be closed.

In an example, the file can be compressed (such as using gzip format) to have a smaller size, which will be even more efficient for the following transfer. In this embodiment, the file can be named _table_bulkget_transactionid.gz. An example of the File format will be explained below.

As described above, the table_bulkget_file is in binary format and the table_bulkget_file is gzipped and has a suffix of .gz. The name of the table_bulkget_file is in a format of: _table_bulkget_transactionid.gz. In this example, the table_bulkget_file contains the following two parts:

1) File Header

FIG. 3 is an exemplary diagram showing an example of the file header of the created file according to an embodiment of the disclosure.

As shown in the table of FIG. 3, the first 64 bytes of table_bulkget_file is used for file header. In the table, it is shown that:

Byte sequence 0 has 1 byte to indicate the file format version. Byte sequences 1 to 4 have 4 bytes to indicate how many rows of data in table data field right after the file header. Byte sequences 5 to 15 have 11 bytes to follow the standard DateAndTime definition in SNMPv2 MIB, which indicates the time when the file is generated. Byte sequences 16 to 19 have 4 bytes to indicate the transaction ID for distinguishing each different tftp getbulk transaction. The transaction ID can be generated by the NE before preparing the tftp getbulk file and set its value to tftpBulkGetTransactionId. Then the NMS will use the transaction ID for retrieving a file. Byte sequences 20 to 23 have 4 bytes to indicate the table code, which refers to the value of tftpBulkGetTableId and is used to indicate which SNMP table will subject to a SNMP getbulk operation. Byte sequences 24 to 63 have 40 bytes reserved for future use. They can all initially set to 0.

2) Table Data

The table data follows table indication. It has variable length and is composed of rows of the table in sequence. Each row follow the definition below: i) Multiple sequenced objects in the table, including all objects in the table and the index, if the index objects are not defined in table; and ii) Each row is in a format of data block, which is defined in the NMS side.

According to the result of the above file creation, the NE can change the tftpBulkGetTransactionStatus of the corresponding row into complete(3) indicating the process is completed; or failure(4) indicating the process failed due to something wrong during the above processing. In this case, the NE can waiting for the NMS to retrieve tftpBulkGetTransactionStatus.

In another example, the NE can notify the NMS the process of the file creation is completed. The notification can be implemented with a SNMP trap or a SNMP event. The code below shows an example of the trap definition, which is a standard SNMP trap with SNMP objects as tftpBulkGetTableId, tftpBulkGetTransactionId, tftpBulkGetTransactionStatus.

```
tftpGetBulkNotificationTrap NOTIFICATION-TYPE
  OBJECTS { tftpBulkGetTableId,
    tftpBulkGetTransactionId,
    tftpBulkGetTransactionStatus }
  STATUS current
  DESCRIPTION
    ″This trap/event indicates that the state of
    a SNMP tftp getbulk transaction status has changed.
    The following variables are returned:
      tftpBulkGetTableId - current Table Id for the transaction,
      tftpBulkGetTransactionId - current getbulk transaction id,
      tftpBulkGetTransactionStatus - current getbulk transaction status
      ″
::= { tftpGetBulkTraps 1 }
```

When the NMS receives this SNMP trap from the NE, it will be informed on a transaction and its processing status accordingly.

The NE will set a transaction ID for each table_bulkget_file. In an example, the transaction ID can be 4-byte long and be initiated to 1 per node reset. It be incremented per each table bulkget request and can be rollover to 1 once it reaches the maximum value of 0xFFFFFFFF.

At step S102, the NMS receives the file by TFTP.

In one example, the NMS checks the availability of the file transfer before receiving the file by TFTP.

In this example, the NMS can get the transaction ID from the NE by SNMP after the transmission of the request.

The NMS can also get the status of the file creation indicated by the transaction ID by SNMP. This get process can be done periodically. For example, the period can be set to 2 seconds.

If the status indicates that the file creation is completed, the NMS TFTP get the corresponding table_bulkget_file from the NE. After the file transfer is successful, NMS then sends another SNMP Set request by setting tftpBulkGetTableId and tftpBulkGetRowStatus's value to be destroy(6). When NE receives this request, it will remove the row from tftpBulkGetTable, and deletes the corresponding file from NE side, as this transaction is completed and the file is of no use for NE now. By this way, the whole transaction is finished. The NMS can use binary command for TFTP get. It can be appreciated that the NMS can then parse the file in binary format and represent to an end user in GUI or store into backend database.

If the status indicates that the file creation is failed, the NMS can initiate a new table bulkget request.

The embodiment is described with reference to the TFTP file transfer protocol. However, other network file transfer protocol can also be used. For example, FTP protocol can be used in the embodiment of the disclosure for the transfer of created file in the binary format according to the embodiment of the disclosure. Compared with the TFTP protocol described above, FTP requires a user name and password for the file transfer, which are not needed for the file transfer by TFTP.

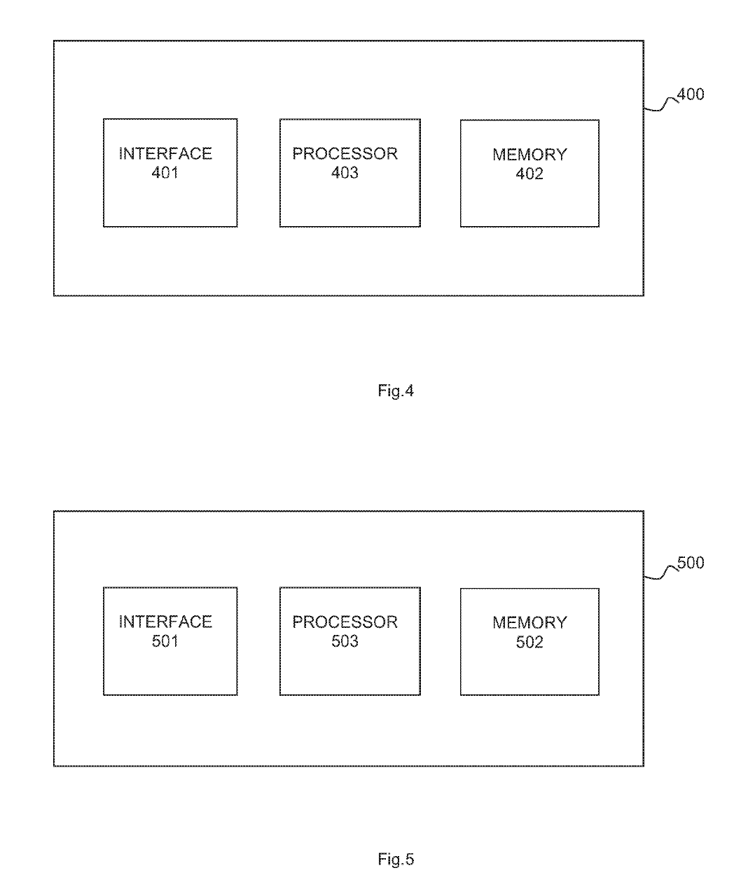

FIG. 4 is a block diagram schematically showing a NE according to an embodiment of the present disclosure.

As shown in FIG. 4, the NE 400 can comprise an interface 401, a memory 402 and a processor 403.

The interface 401 can serve as an interface between the NE 400 and an external network device to transmit packets from the NE 400 to the external device or receive packets from the external device. In one example, the external network device is a server functioning as a NMS.

The memory 402 can store data received from the outside, data required for operations of the NE 400, and/or data resulting from the operations of the apparatus 400. In one example, the memory 402 can store data in the form of a SNMP MIB table for the communication with an external network device according to the SNMP protocol.

The processor 403 can be configured to perform methodologies described above. More specifically, the processor 403 is configured to receive from a NMS a request for retrieving data from a SNMP table; and create a file which includes data of the SNMP table and supports TFTP server function. The processor 403 can comprise any suitable device capable of performing desired processing. For example, the processor 403 can be a general central processing unit (CPU), an application specific integrated circuit (ASIC), a digital signal processor (DSP) or a field programmable gate array (FPGA).

FIG. 5 is a block diagram schematically showing a NMS according to an embodiment of the present disclosure.

As shown in FIG. 5, the NMS 500 can comprise an interface 501, a memory 502 and a processor 503.

The interface 501 can serve as an interface between the NMS 500 and an external network device to transmit packets from the NMS 500 to the external device or receive packets from the external device. In one example, the external network device is a NE in the network.

The memory 502 can store data received from the outside, data required for operations of the NMS 500, and/or data resulting from the operations of the apparatus NMS 500. In one example, the memory 502 can store data in the form of a SNMP MIB table for the communication with an external network device according to the SNMP protocol.

The processor 503 can be configured to perform methodologies described above. More specifically, the processor 503 is configured to transmit, to a NE, a request for retrieving data from a SNMP table; and receive a file from the first network device (NE) by TFTP. The processor 503 can comprise any suitable device capable of performing desired processing. For example, the processor 503 can be a general central processing unit (CPU), an application specific integrated circuit (ASIC), a digital signal processor (DSP) or a field programmable gate array (FPGA).

It is to be further understood that, because some of the constituent system components and method steps depicted in the accompanying figures are preferably implemented in software program, the actual connections between the system components (or the process steps) may differ depending upon the manner in which the present disclosure is programmed. Given the teachings herein, one of ordinary skill in the related art will be able to contemplate these and similar implementations or configurations of the present disclosure.

1. A method for data transfer between a first network device (NE) and a second network device (NMS), comprising, at the level of the first network device (NE),
receiving, from the second network device, a request for retrieving data from a SNMP (Simple Network Management Protocol) table; and
creating a file which includes data of the SNMP table and supports a network file transfer protocol.

2. Method according to claim 1, wherein the first network device (NE) is a network element and the second network device (NMS) is a server.

3. Method according to claim 1, further comprising
creating a new row in the SNMP table for indicating whether the process of the file creation is completed.

4. Method according to claim 1, further comprising
transmitting a message to the second network device to notify the second network device that the process of the file creation is completed.

5. Method according to claim 1, further comprising
compressing the created file.

6. Method according to claim 1, wherein the network file transfer protocol is TFTP (Trivial File Transfer Protocol).

7. Method according to claim 1, wherein the network file transfer protocol is FTP (File Transfer Protocol).

8. A method for data transfer between a first network device (NE) and a second network device (NMS), comprising, at the level of the second network device (NE),
transmitting, to the first network device (NE), a request for retrieving data from a SNMP table; and
receiving a file from the first network device (NE) by a network file transfer protocol.

9. Method according to claim 8, wherein the first network device (NE) is a network element and the second network device (NMS) is a server.

10. Method according to claim 8, further comprising:
checking the availability of the file transfer before receiving the file.

11. Method according to claim 10, wherein the checking comprising:
retrieving the SNMP table of the first network device (NE) to get a transaction ID of the request and a status indicating whether a creation a file indicated by the transaction ID is completed.

12. Method according to claim 10, wherein the checking comprising
receiving a message from the first network device (NE) notifying that the process of the file creation is completed.

13. Method according to claim 8, wherein the request is in the form of a SNMP Set command

14. Method according to claim 8, wherein the network file transfer protocol is TFTP (Trivial File Transfer Protocol).

15. Method according to claim 8, wherein the network file transfer protocol is FTP (File Transfer Protocol).

16. An apparatus, comprising:
an interface configured to exchange packets with an external device;
a memory configured to store data required for operation of the apparatus; and
a processor configured to:
receive, from the external device, a request for retrieving data from a SNMP table; and
create a file which includes data of the SNMP table and supports a network file transfer protocol.

17. Apparatus according to claim 16, wherein the apparatus functions as a network element.

18. An apparatus comprising:
an interface configured to exchange packets with an external device;
a memory configured to store data required for operation of the apparatus; and
a processor configured to:
transmit, to the external device, a request for retrieving data from a SNMP table; and
receive a file from the external device by a network file transfer protocol.

19. Apparatus according to claim 18, wherein the apparatus functions as a network management server.
